(19) United States
(12) Patent Application Publication
(10) Pub. No.: US 2006/0060760 A1
(43) Pub. Date: Mar. 23, 2006

(54) Optical imaging system

(76) Inventor: Tzu-Hsuan Lan, Kweishan (TW)

Correspondence Address: HOFFMAN WARNICK & D'ALESSANDRO, LLC, 75 STATE STREET, 14TH FL, ALBANY, NY, 12207, US

(21) Appl. No.: 11/230,096

(22) Filed: Sep. 19, 2005

(30) Foreign Application Priority Data
Sep. 21, 2004 (TW) 093128585

(51) Int. Cl. H01J 3/14

(52) U.S. Cl. 250/216

(57) ABSTRACT

This invention discloses an optical imaging system, which includes an imaging unit, at least one first light guiding unit, and at least one second light guiding unit, for imaging an image for an object in a space. The imaging unit defines a first side and a second side. A first optical path is defined from the object to the first side, and a second optical path is defined from the second side to the image. The first light guiding units are disposed at the first optical path for guiding a light from the object passing through in the first optical path. The second light guiding units are disposed at the second optical path for guiding the light further passing through in the second optical path, such that the image is imaged in the space to reduce the size of the optical imaging system.

### BACKGROUND OF THE INVENTION

1. Field of the Invention

The present invention relates to an optical imaging system, and more particular to an optical imaging system whose size is further reduced.

2. Description of the Prior Art

Referring to FIG. 1, FIG. 1 is a schematic diagram of the optical imaging system 10 of the prior art. The optical imaging system 10 is used for imaging an image 14 for an object 12 in a space 18. The optical imaging system 10 includes an imaging unit 16. The imaging unit 16 is used for receiving a light form the object 12 and imaging the image 14 in the space 18. As shown in FIG. 1, in the prior art, the light from the object 12 and the light imaging the image 14 are independent, such that the size of the optical imaging system 10 is too large.

Referring to FIG. 2, FIG. 2 is a schematic diagram of the optical imaging system 11 with the reflectors 22 and 24. In the optical imaging system 11, the two reflectors 22 and 24 are respectively disposed at the different sides of the imaging unit 16 and are used for changing the light path. The imaging unit 16 is used for receiving a light from the object 12 and the reflector 22 and then for outputting the light to image the image 14 in the space 18 via the reflector 24. Compared to the optical imaging system 10 shown in FIG. 1, the optical imaging system shown in FIG. 2 utilizes the reflectors to change the light path, so as to reduce the size of the system. However, in the optical imaging system 11, the light from the object 12 and the light imaging the mage 14 are still independent. In other words, one light path doesn't cross the other, so the size of the optical imaging system is still too large.

### SUMMARY OF THE INVENTION

The objective of the present invention is to provide an optical imaging system. The optical imaging system utilizes the light guiding unit to change the light path. Alternatively, the first optical path crosses the second optical path, or an extended virtual path of the first optical path crosses an extended virtual path of the second optical path, such that the size of the optical imaging system is effectively reduced.

The other objective of the present invention is to provide an optical imaging system. The optical imaging system utilizes at least one first light guiding unit and at least one second light guiding unit to change the light path, so as to reduce the size of the optical imaging system. Furthermore, the at least one first light guiding unit and the at lest one second light guiding unit use at least one unit in common to reduce the amount of the light guiding units.

The present invention provides an optical imaging system for imaging an image for an object in a space. The optical imaging system includes an imaging unit, at least one first light guiding unit, and at lest one second light guiding unit. The imaging unit defines a first side and a second side. A first optical path is defined from the object to the first side of the imaging unit. A second optical path is defined from the second side of the imaging unit to the image. The first light guiding units are disposed at the first optical path and are used for guiding a light from the object passing through in the first optical path. The second light guiding units are disposed at the second optical path and are used for guiding the light further passing through in the second optical path. Alternatively, based on the arrangement of the first light guiding units and the second light guiding units, the first optical path crosses the second optical path, or an extended virtual path of the first optical path crosses an extended virtual path of the second optical path, such that the image is imaged in the space.

Compared to the prior art, the optical imaging system of the present invention utilizes the light guiding units to change the light path, such that alternatively, one light path crosses the other, or an extended virtual path of one light path crosses an extended virtual path of the other, so as to effectively reduce the size of the optical imaging system.

The advantage and spirit of the invention may be understood by the following recitations together with the appended drawings.

### BRIEF DESCRIPTION OF THE APPENDED DRAWINGS

FIG. 1 is a schematic diagram of the optical imaging system of the prior art.

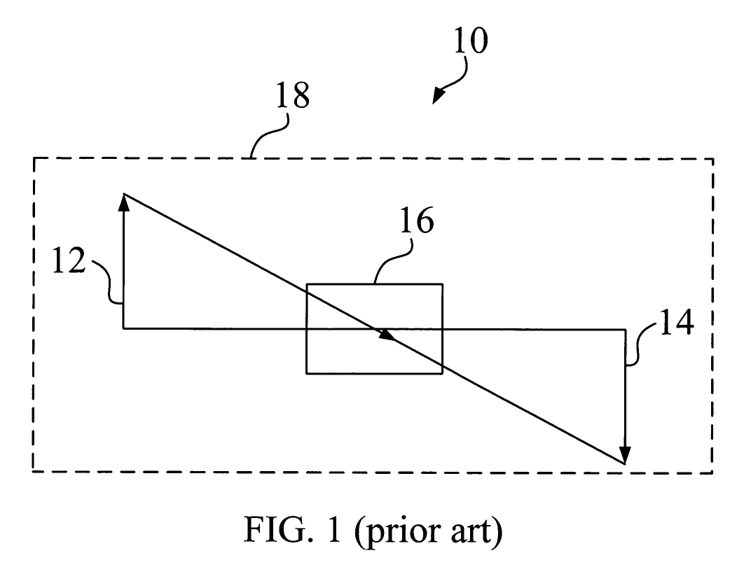

FIG. 2 is a schematic diagram of the optical imaging system with the reflectors.

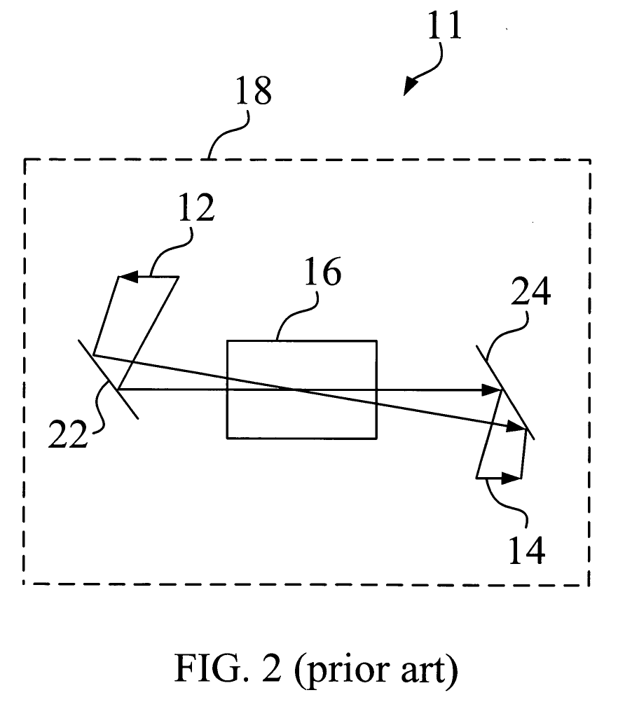

FIG. 3 is a schematic diagram of the optical imaging system according to the present invention.

FIG. 4 is a schematic diagram of the optical imaging system according to another embodiment of the present invention.

FIG. 5 is a schematic diagram of the optical imaging system according to another embodiment of the present invention.

FIG. 6 is a schematic diagram of the optical imaging system according to another embodiment of the present invention.

FIG. 7 is a schematic diagram of the optical imaging system according to another embodiment of the present invention.

### DETAILED DESCRIPTION OF THE INVENTION

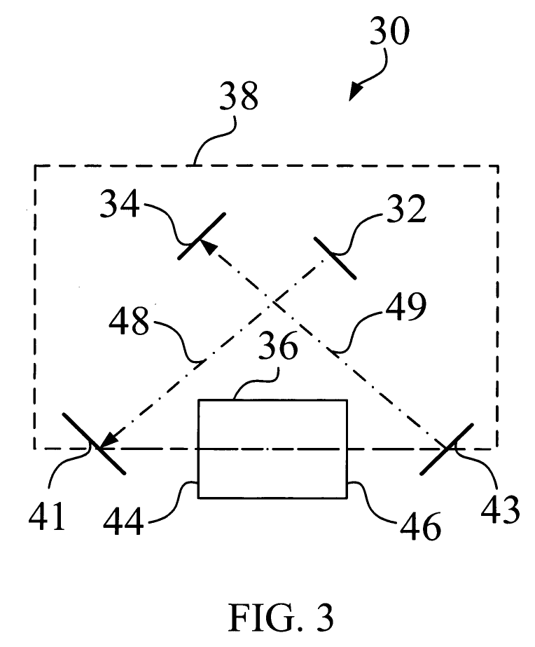

Referring to FIG. 3, FIG. 3 is a schematic diagram of the optical imaging system 30 according to the present invention. The optical imaging system 30 of the present invention includes an imaging unit 36, a first light guiding unit 41, and a second light guiding unit 43. The imaging unit 36 may be a lens or other optical components. The light guiding units 41 and 43 may be a reflector or other components capable of changing the light path.

The optical imaging system 30 is sued for imaging an image 34 for an object 32 in a space 38. The imaging unit 36 defines a first side 44 and a second side 46. A first optical path 48 is defined from the object 32 to the first side 44 of the imaging unit 36. A second optical path 49 is defined from the second side 46 of the imaging unit 36 to the image 34. To describe the figure more clearly, the optical paths shown in FIG. 3 are marked by a center line.

As shown in FIG. 3, the first light guiding unit 41 is disposed at the first optical path 48 and is used for guiding a light from the object 32 passing through in the first optical path 48. The second light guiding unit 43 is disposed at the second optical path 49 and is used for guiding the light further passing through in the second optical path 49. The first optical path 48 further crosses the second optical path 49, such that the image 34 is imaged in the space 38. In this embodiment, based on the arrangement of the first light guiding unit 41 and the second light guiding unit 43, the first optical path 48 substantially crosses the second optical path 49, such that the size of the optical imaging system 30 is reduced.

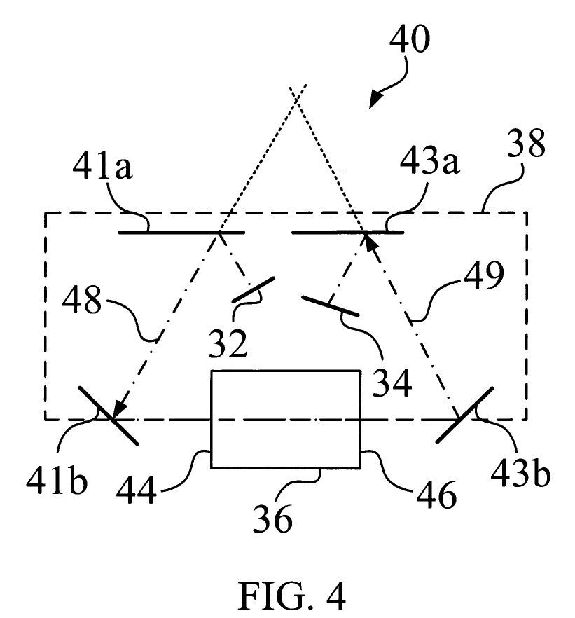

Referring to FIG. 4, FIG. 4 is a schematic diagram of the optical imaging system 40 according to another embodiment of the present invention. The center lines in FIG. 4 are used for marking the optical paths. The main difference between the optical imaging system 40 and the optical imaging system 30 is that the optical imaging system 40 includes two first light guiding units (41a, 41b) and two second light guiding units (43a, 43b), such that an extended virtual path of the first optical path 48 crosses an extended virtual path of the second optical path 49 in the optical imaging system 40. In other words, based on the arrangement of the light guiding units, there is a virtual crossing (as the thin dotted line shown in FIG. 4) behind the first light guiding unit 41a and the second light guiding unit 43a. The size of the optical imaging system is smaller than the optical imaging system 30. The imaging principle of the optical imaging system 40 shown in FIG. 4 is the same as the optical imaging system 30 shown in FIG. 3, and it won't be described again.

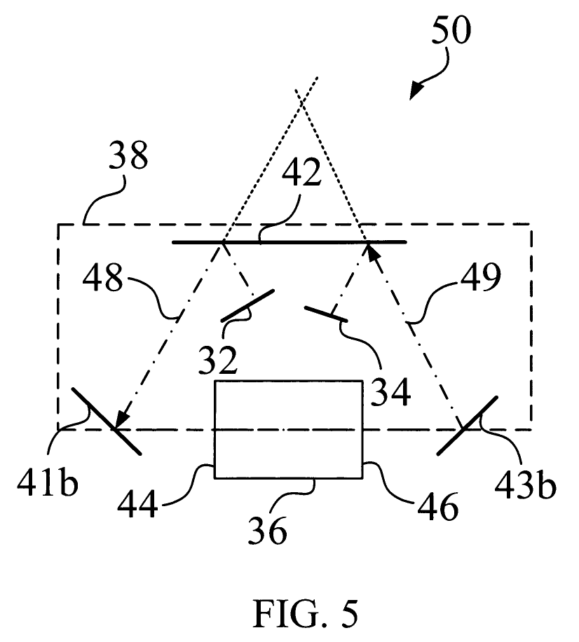

Referring to FIG. 5, FIG. 5 is a schematic diagram of the optical imaging system 50 according to another embodiment of the present invention. The center lines in FIG. 5 are used for marking the optical paths. The main difference between the optical imaging system 50 and the optical imaging system 40 is that a first light guiding unit 41 and a second light guiding unit 43 are used in common as a light guiding unit 42 in the optical imaging system 50. Compared to the optical imaging system 40, the optical imaging system 50 utilizes the light guiding unit 42 to further reduce the amount of the light guiding units. The imaging principle of the optical imaging system 50 shown in FIG. 5 is the same as the optical imaging systems 30 and 40 shown in FIGS. 3 and 4, and it won't be described again.

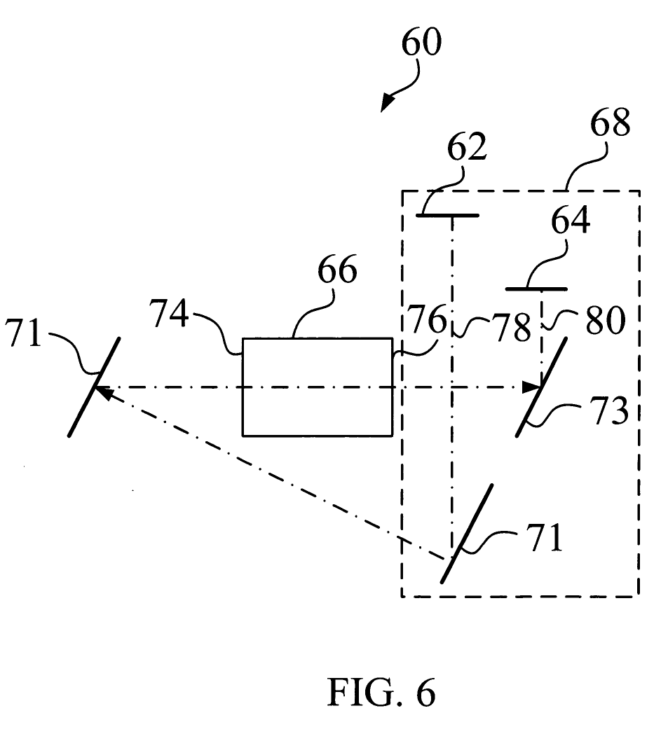

Referring to FIG. 6, FIG. 6 is a schematic diagram of the optical imaging system 60 according to another embodiment of the present invention. The optical imaging system 60 includes an imaging unit 66, at least one first light guiding unit 71, and at least one second light guiding unit 73. The imaging unit 66 may be a lens or other optical components. The light guiding units 71 and 73 may be a reflector or other components capable of changing the light path. The optical imaging system 60 is sued for imaging an image 64 for an object 62 in a space 68. The imaging unit 66 defines a first side 74 and a second side 76. A first optical path 78 is defined from the object 62 to the first side 74 of the imaging unit 66. A second optical path 80 is defined from the second side 76 of the imaging unit 66 to the image 64. To describe the figure more clearly, the optical paths shown in FIG. 6 are marked by a center line.

As shown in FIG. 6, the first light guiding unit 71 is disposed at the first optical path 78 and is used for guiding a light from the object 62 passing through in the first optical path 78. The second light guiding unit 73 is disposed at the second optical path 80 and is used for guiding the light further passing through in the second optical path 80. The second optical path 80 further crosses the first optical path 78, such that the image 64 is imaged in the space 68. In this embodiment, based on the arrangement of the first light guiding unit 71 and the second light guiding unit 73, the first optical path 78 substantially crosses the second optical path 80, such that the size of the optical imaging system 60 is reduced.

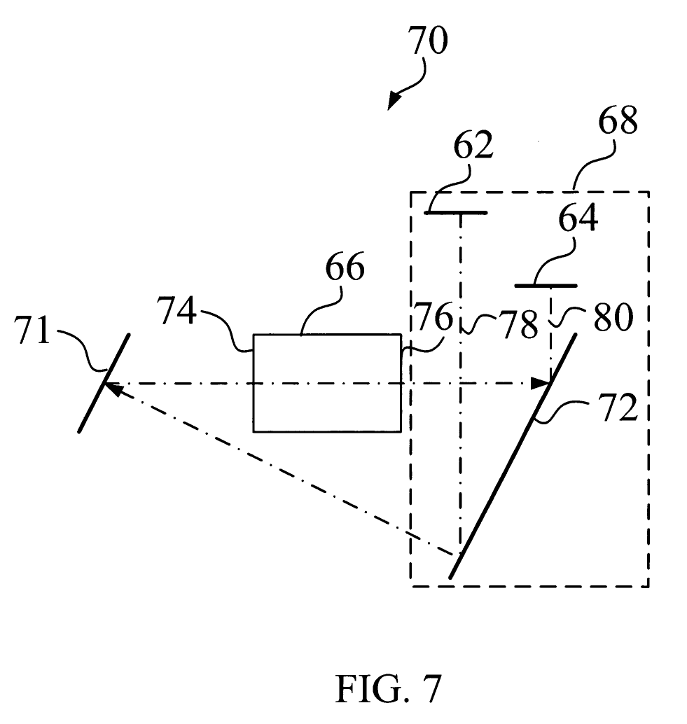

Referring to FIG. 7, FIG. 7 is a schematic diagram of the optical imaging system 70 according to another embodiment of the present invention. The center lines in FIG. 7 are used for marking the optical paths. The main difference between the optical imaging system 70 and the optical imaging system 60 is that a first light guiding unit 71 and a second light guiding unit 73 are used in common as a light guiding unit 72 in the optical imaging system 70. Compared to the optical imaging system 60, the optical imaging system 70 utilizes the light guiding unit 72 to further reduce the amount of the light guiding units. The imaging principle of the optical imaging system 70 shown in FIG. 7 is the same as the optical imaging systems 60 shown in FIG. 6, and it won't be described again.

The optical imaging system of the present invention can be applied to various optical apparatuses or image process apparatuses, e.g. scanner and so on. For example, when the optical imaging system of the present invention is applied to a scanner, the size of the scanner can be reduced effectively.

Compared to the prior art, the optical imaging system of the present invention utilizes the light guiding units to change the light path. Furthermore, alternatively, based on the arrangement of the light guiding units, one light path crosses the other, or an extended virtual path of one light path crosses an extended virtual path of the other, such that the size of the optical imaging system is effectively reduced. Moreover, the optical imaging system of the present invention reduces the amount of the light guiding units by using at least one light guiding unit in common.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical imaging system for imaging an image for an object in a space, said system comprising:
an imaging unit defining a first side and a second side, a first optical path being defined from the object to the first side of the imaging unit, and a second optical path being defined from the second side of the imaging unit to the image;
at least one first light guiding unit, disposed at the first optical path, for guiding a light from the object passing through in the first optical path; and
at lest one second light guiding unit, disposed at the second optical path, for guiding the light further passing through in the second optical path;
wherein alternatively, based on the arrangement of the first light guiding units and the second light guiding units, the first optical path crosses the second optical path, or an extended virtual path of the first optical path crosses an extended virtual path of the second optical path, such that the image is imaged in the space to reduce the size of the optical imaging system.

2. The optical imaging system of claim 1, wherein the imaging unit is a lens.

3. The optical imaging system of claim 1, wherein the at least one first light guiding unit and the at lest one second light guiding unit use at least one unit in common.

4. The optical imaging system of claim 1, wherein each of the first light guiding units is a reflector respectively.

5. The optical imaging system of claim 1, wherein each of the second light guiding units is a reflector respectively.
